(19) United States
(12) Patent Application Publication
(10) Pub. No.: US 2026/0300754 A1
(43) Pub. Date: Oct. 1, 2026

(54) A METHOD FOR A FLEXIBLE AND ADAPTABLE END-TO-END COMMUNICATION USING A TWO-SIDED MACHINE LEARNING MODEL

(71) Applicant: Lenovo (Singapore) Pte. Limited, Singapore (SG)

(72) Inventors: Venkata Srinivas Kothapalli, Aurora, IL (US); Vijay Nangia, Woodridge, IL (US); Vahid Pourahmadi, München (DE); Ahmed Hindy, Aurora, IL (US)

(73) Assignee: Lenovo (Singapore) Pte. Limited, Singapore (SG)

(21) Appl. No.: 19/156,977

(22) PCT Filed: Feb. 16, 2024
(86) PCT No.: PCT/IB2024/051525

§ 371 Date: Aug. 15, 2025

Related U.S. Application Data
(60) Provisional application No. 63/485,430, filed on Feb. 16, 2023.

(51) Int. Cl. G06N 3/0985; G06N 3/0455

(52) U.S. Cl. CPC G06N 3/0985; G06N 3/0455

(57) ABSTRACT

A method implemented at a first device of a radio communication network comprising training an encoder, wherein the encoder comprises an AI/ML model to generate a first number of complex-valued symbols from an input message. The training is carried out based on an objective function comprising input messages, respective complex-valued symbols, and a function representative of the wireless transmission link as inputs. The trained encoder is then used to encode a further input message and generate further complex-valued symbols, whereupon the further complex-valued symbols are transmitted to a second device.

### RELATED APPLICATION

This application claims priority to U.S. Provisional Application Ser. No. 63/485,430 filed 16 Feb. 2023 entitled “A METHOD FOR A FLEXIBLE AND ADAPTABLE END-TO-END COMMUNICATION USING A TWO-SIDED MACHINE LEARNING MODEL,” the disclosure of which is incorporated by reference herein in its entirety.

### TECHNICAL FIELD

The technical field is the training of encoders and decoders comprising artificial intelligence/machine learning (AI/ML) models for use in a radio communication network.

### BACKGROUND

Artificial intelligence/machine learning (AI/ML) based end-to-end (E2E) wireless communication systems represent a new paradigm for wireless communications, and are being actively considered for the next generation AI-native wireless networks.

In order to enable E2E communication through AI/ML methods, the focus is on two-sided AI/ML models, wherein one model is employed at the transmitting end, and which works in tandem with another model employed at the receiving end of the communication link.

A wireless network, in practice, is a multi-user network in the sense that at any given time, multiple users are served by a base station (gNB) or an access point (AP). In a typical wireless cellular network, multiple user equipments (UEs), are connected to a single gNB at a given time. For downlink communication (from gNB to UEs) in such a network, encoders are located at the gNB and each UE comprises a decoder.

In existing solutions, encoders and decoders which work together need to be trained together. However, it might not be practical to ensure that all the decoders are trained jointly with the encoder EL. This problem is further accentuated by the fact that the UEs, being mobile, will move in and out of the coverage area of the gNB and thus become connected to other gNBs. It would be very difficult, if not practically infeasible, to ensure a situation where the decoders employed at different UEs are trained jointly with, and perfectly matched to, the encoders employed at the base stations.

### SUMMARY OF INVENTION

According to a first aspect, there is provided a method implemented at a first device of a radio communication network. The method comprises training an encoder, wherein the encoder comprises an AI/ML model to generate a first number of complex-valued symbols from an input message. The training is carried out based on an objective function comprising input messages, respective complex-valued symbols, and a function representative of the wireless transmission link as inputs. The trained encoder is then used to encode a further input message and generate further complex-valued symbols, whereupon the further complex-valued symbols are transmitted to a second device.

In an embodiment, wherein the training is carried out to maximize the objective function.

In an embodiment, the objective function computes a measure of mutual information between the input message, and a function of communication channel information and the generated first number of complex-valued symbols.

According to a second aspect, there is provided a method implemented at a second device of a radio communication network. The method comprises receiving a set of channel output symbols corresponding to an input message and the corresponding input message. A decoder comprising an AI/ML model is trained to generate the input message from the channel output symbols corresponding to the input message, wherein the training determines a second set of parameters of the decoder based on an objective function taking the generated input message and the received channel output symbols corresponding to the input message as inputs, wherein the objective function computes a measure of cross entropy between the generated input message and at least a part of the channel output symbols corresponding to the input message.

In an embodiment, wherein the training is carried out to minimize the objective function.

According to a third aspect, there is provided a method implemented at a second device of a radio communication network. The method comprises receiving a set of channel input symbols corresponding to an input message and the corresponding input message. Information representing channel information is received or determined and the channel information is applied to the set of channel input symbols in order to generate a set of channel output symbols corresponding to the input message. A decoder comprising an AI/ML model is trained to generate the input message from the channel output symbols corresponding to the input message, wherein the training determines a second set of parameters of the decoder based on an objective function taking the generated input message and the received channel output symbols corresponding to the input message as inputs, wherein the objective function computes a measure of cross entropy between the generated input message and at least a part of the channel output symbols corresponding to the input message.

In an embodiment, wherein the training is carried out to minimize the objective function.

According to a fourth aspect, there is provided a method implemented at a first device of the radio communication network, the first device comprising an encoder comprising a AI/ML model trained to operate using a first set of parameters. The method comprises at the first device, determining whether to update at least a portion of the encoder. A signal is received from a second device, and information regarding the communication channel is determined from the received signal. In response to determining to update the encoder AI/ML mode the first set of parameters is updated based on the determined information of the communication channel. The encoder is then used to encode an input message and generate complex-valued symbols using the updated first parameters, and the complex-valued symbols are transmitted to the second device.

According to a fifth aspect, there is provided a method implemented at a first device of the radio communication network, the first device comprising an encoder comprising a AI/ML model trained to operate using a first set of parameters. The method comprises encoding, by the encoder, an input message into an output comprising d number of complex-valued symbols. A determination is made as to whether to apply a transformation to then output of the encoder. In response to determining to transform the output, the output is transformed using a unitary matrix, of size d×d. The transformed complex-valued symbols are then transmitted over the channel.

According to a sixth aspect, there is provided a device comprising a transmitter, a receiver, a memory and a processor, configured to implement the methods of any one of the first to fifth aspects.

### BRIEF DESCRIPTION OF DRAWINGS

FIG. 1 is a diagram illustrating a typical wireless communication system in which an artificial intelligence/machine learning (AI/ML) based encoders and decoders may be deployed;

FIG. 2 is a diagram illustrating the interaction of the components, inputs and outputs of such a wireless communication system;

FIG. 3 is a diagram illustrating the encoding and transmission of an input message;

FIG. 4 is a flow chart illustrating a method of training an encoder according to an embodiment;

FIG. 5 is a diagram illustrating the interaction of the output yi of the channel, the decoder and the decoded message;

FIG. 6 is a flow chart illustrating a method of training a decoder according to an embodiment;

FIG. 7 is a diagram illustrating the interaction of the input xᵢ of the channel 702, i.e. the symbols generated by the output yi of the channel, the decoder and the decoded message;

FIG. 8 is a flow chart illustrating a method of training a decoder according to an embodiment;

FIG. 9 is a flow chart illustrating a method of updating the encoder AI/ML model according to an embodiment;

FIG. 10 is a flowchart illustrating a method of implementing a transformation according to an embodiment; and

FIG. 11 is a diagram illustrating a device for implementing a method according to any of the previous embodiments.

### DETAILED DESCRIPTION

Different methods have been proposed for training AI/ML models, such as autoencoders, for E2E communications. They primarily differ in how they take care of channel model. That is, some of the models assume a mathematical/analytical channel model that is differentiable, some methods use Generative Adversarial Networks (GAN) to replace a physical channel. However, all these methods train the encoder and the decoder in such a way that, for each input message, the decoding error probability at the output of the decoder is minimized.

There exists another method that trains the decoder at the receiver separately from the encoder at the transmitter. However, in this method the encoder and decoder are not trained independently, and the objective of this training method is also to minimize the decoding error probability at the output of the decoder. Thus, the resulting encoder and the decoder are still paired or matched with each other, and, additionally, the encoder is not guaranteed to provide optimal mapping between messages and symbols.

It is further necessary to enable the updating of an encoder in order to deal with changing channel conditions. The following methods have been proposed to address this issue:

The classification of the channels based on their statistical characteristics, followed by the training of several autoencoders, one for each type of channel. All of the autoencoders are deployed (i.e., all the encoders at the transmitting node and all the decoders at the receiving node) but only one of the autoencoders (i.e., one encoder at the transmitting node and one decoder at the receiving node)is activated at any given time, based on the type of wireless channel encountered at that time.

The above method, of training several autoencoders, suffers from multiple disadvantages:
Training and deploying multiple autoencoders is costly.
At any given time, the method needs a mechanism to reliably determine type of channel currently being presented by the physical propagation medium and the characteristics of the input messages to be sent over the channel.
There is no guarantee that the types of channels encountered by the communication link belongs to the set of channels for which the autoencoders are trained. Channel conditions may occur which do not occur during the training phase.

Training an auto-encoder over many types of channel distributions. The basic premise behind such a method is that training a model over many channel distributions, and thus, training it over many data sets that are rich in diversity, makes the model generalizable to unseen channel distributions. Such a premise may not always be valid and may not result in the best possible generalizability as no direct knowledge about the channel distribution is utilized in such methods. Further, such training techniques require large amounts of data from multiple source domains and significant amounts of computational resources for training.

A method of separate and independent training of encoders and decoders, which will enable adaptation to different channel conditions is therefore needed.

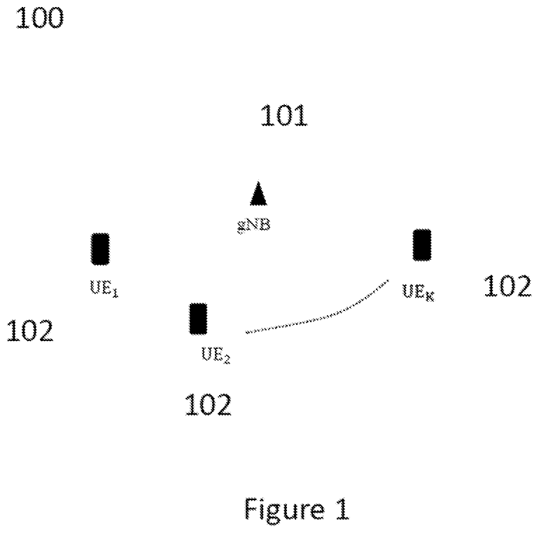

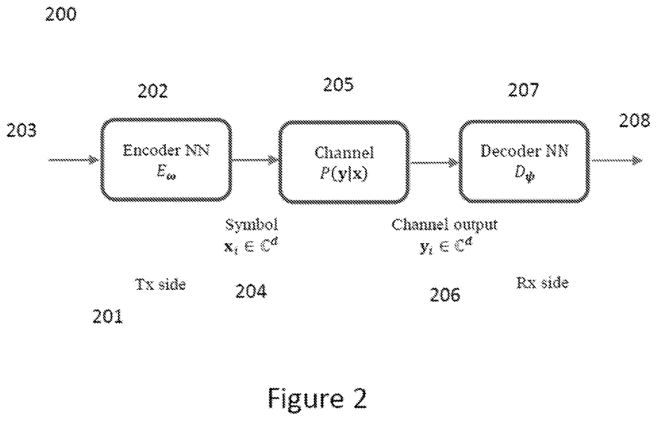

FIG. 1 is a diagram illustrating a typical wireless communication system in which an artificial intelligence/machine learning (AI/ML) based encoders and decoders may be deployed. FIG. 1 shows a typical wireless network, 100, with a base station, 101, known as a “g node B” (gNB), and a plurality of user equipments UEs, 102. For downlink communication, from the base station to the UEs, there is provided encoders at the base station and decoders at the UEs. FIG. 2 is a diagram illustrating the interaction of the components, inputs and outputs of such a wireless communication system 200. The transmitter side 201 comprises an encoder 202, which receives an input message 203, encodes the message to produce a set of complex symbols 204. The symbols 204 are transmitted across the channel 205, which results in an altered set of symbols, i.e. the channel output 206. The decoder 207 receives and decodes the channel output 206, to generate a recovered message 208.

The encoders and decoders comprise artificial intelligence/machine learning (AI/ML) models. In embodiments, the artificial intelligence/machine learning (AI/ML) model may comprise a neural network, and any of the embodiments herein described may be implemented using a neural network. “Encoder”, and “encoder AI/ML model” are used synonymously. Similarly, “decoder”, and “decoder AI/ML model” are used synonymously.

For the implementation of an artificial intelligence/machine learning (AI/ML) based end-to-end (E2E) wireless communication system, an autoencoder (AE), which is a popular deep learning (DL) model, is a natural choice. An AE is a two-sided AI/ML model that consists of an encoder neural network E_{ω}), a deep neural network (DNN) with learnable/trainable parameters denoted by ω, and a decoder neural network D_{Ψ}, another DNN with Ψ as its set of trainable parameters. In embodiments, the encoder AI/ML model, and the decoder AI/ML model, both implemented with neural networks (NN) are trained and developed together such that the signal/data at the input to the encoder NN is reconstructed, as faithfully as possible, at the output of the decoder NN. Thus, the two neural networks, or the two models, E_{ω}, and D_{Ψ}, together constitutes an auto-encoder and denoted as A={E_{ω},D_{Ψ}}.

However, the methods and apparatus herein described are not limited to autoencoders, and are applicable, in general, to any E2E communication system that is based on an AI/ML model based encoder at the transmitting end and an AI/ML model based decoder at the receiving end.

For the ease of exposition, the following embodiments are illustrated using a single-input single-output (SISO) wireless communication system. However, the methods and apparatus herein described are equally applicable to wireless communication systems that are equipped with multiple antennas at the transmitter and/or the receiver, i.e., MISO and/or MIMO wireless communication systems.

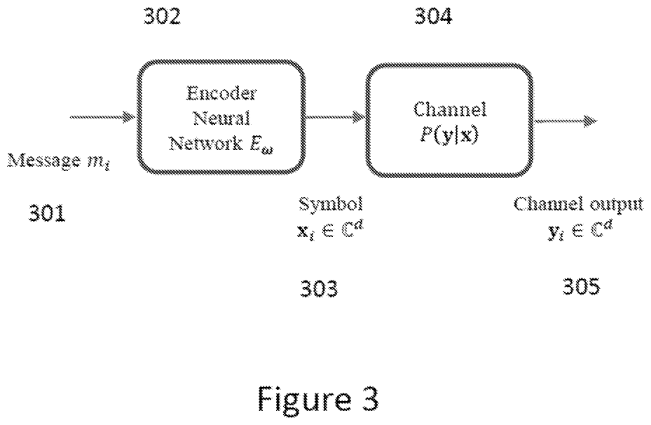

In AI/ML based E2E communications, the primary objective of the encoder is to map/encode input messages mᵢ∈ [symbol] ={1, 2, . . . , M}t into symbols xᵢ∈ [symbol] such that the mapping is optimal with respect to the channel being considered. In other words, encoder should determine xᵢ for each mᵢ such that when symbol xᵢ is sent over the channel the output of the channel yᵢ∈ [symbol] should be able to uniquely represent message mᵢ. Such a behavior of encoder can be ensured by training the encoder based on the mutual information between mᵢ and yᵢ. The higher the mutual information between yᵢ and mᵢ, the higher the information in yᵢ about mᵢ and higher the reliability with which mᵢ can be inferred from yᵢ. FIG. 3 is a diagram illustrating the encoding and transmission of an input message. The input message 301 is input into the encoder 302, wherein the latter encodes the input message 301 to produce symbols 303, which are then transmitted across the channel 304, resulting in a channel output 305.

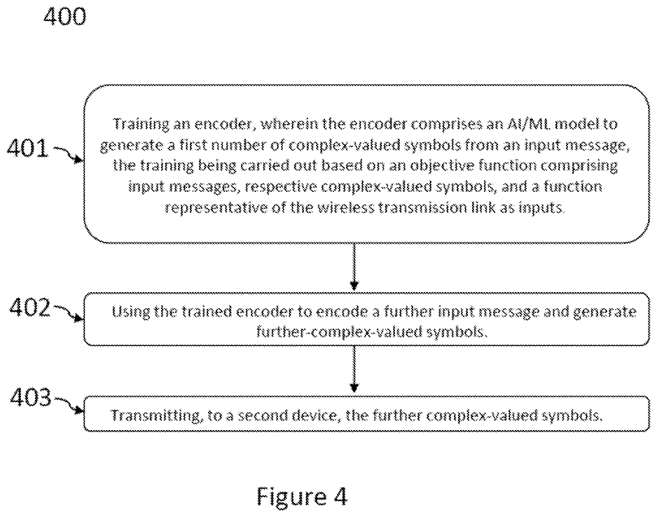

FIG. 4 is a flow chart illustrating a method 400 implemented at a first device of a radio communications network. The method applies when the first device is acting as a transmitting device.

The method comprises training 401, the encoder, wherein the encoder comprises an AI/ML model. The purpose of the model is to generate a first number of complex-valued symbols from an input message to be transmitted over a wireless transmission link of the radio communication network. The training is carried out based on an objective function comprising input messages, respective complex-valued symbols, and a function representative of the wireless transmission link as inputs. In an embodiment, the objective function computes a measure of mutual information between the input message and a function of communication channel information and the generated first number of complex-valued symbols. Typically, the training determines a first set of parameters for using the AI/ML model, wherein the first set of parameters fully specify the encoder AI/ML model and comprise a number of neural layers, a number of neurons in each layer, connections between neurons, weights of each neuron, values of hyper-parameters and details of activation functions in the encoder AI/ML model. Once the AI/ML model has been trained, the encoder can be used 402 to encode a further input message and generate further-complex-valued symbols; and to transmit 403, to a second device, the further complex-valued symbols. In embodiments, the training is carried out to maximize objective function.

In embodiments, the function representative of the wireless transmission link comprises of communication channel information. The communication channel is not the only source of noise and interference for the transmitted signal, and hence, in embodiments, the function representative of the wireless transmission link also comprises hardware imperfections at the first device and the channel quality at the second device.

In order to determine a condition of the channel and hence to determine the function representative of the wireless transmission link, the first device may receive information from other nodes/devices in the network. In embodiments, the first device determines the function representative of the wireless transmission link based at least in part on an indication from one of the second device or a third device, the third device being different from the second device. In embodiments, the information from other nodes includes at least one reference signal from the second node. In embodiments, determining the communication channel information based on the received at least one reference signal.

Once the channel output is received at the receiving device, it must be decoded to recover the original message. This process is performed by a decoder AI/ML model. The task of the decoder in an auto-encoder for E2E communications is to infer the message contained in the channel output. In other words, it has to decode the channel output yᵢ into one of the input messages \hat{m}ᵢ∈{1, . . . , M}, while minimizing the error probability of Pr(\hat{m}ᵢ≠mᵢ). Equivalently, the decoder can be considered as a classifier whose task is to classify the channel output symbol yᵢ into one of the M classes, where each class represents an input message mᵢ. When the encoder is trained to maximize the mutual information between channel output yᵢ and the corresponding input message mᵢ, the symbol yᵢ from the channel contains maximum amount of information about mᵢ, making it possible for an appropriately trained decoder to infer the message mᵢ with a lower probability of error.

In a method according to embodiments, the decoder is trained in a supervised manner with labeled data. The labeled data can be a combination of either: (i) the original message mi and the corresponding output yi of the channel, or (ii) (i) the original message mi and the corresponding input xi to the channel. The former will be referred to as (yᵢ, mᵢ) data, and the latter as (xᵢ, mᵢ) data. Depending on the labeled data available for training the decoder, the training procedure of the decoder can happen in one of the two ways, as explained below.

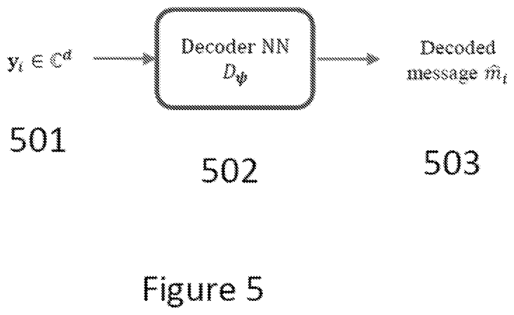

In an embodiment, using data comprising {(yᵢ,mᵢ)ₖ} as the available labelled data, where yᵢ is the channel output symbol corresponding to channel input symbol xᵢ, and where xᵢ is the encoded symbol corresponding to message mᵢ, the training of the decoder AI/ML model comprises supervised learning using a loss function. In an embodiment, the loss function is the cross entropy of the channel output and the message. FIG. 5 is a diagram illustrating a system 500 for the interaction of the output yi of the channel 501, the decoder 502 and the decoded message 503.

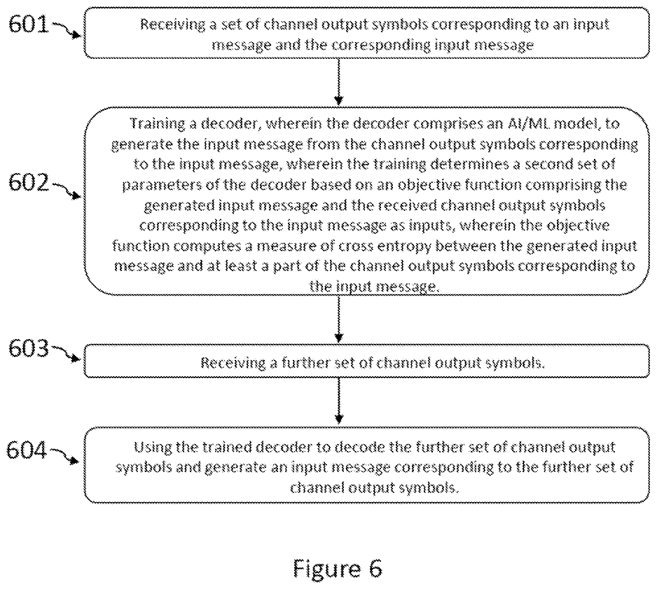

FIG. 6 is a flow chart illustrating a method 600 according to an embodiment, wherein the labelled data comprises (yᵢ, mᵢ) data. The method is implemented in at a second device of a radio communication network. The method comprises receiving 601 a set of channel output symbols corresponding to an input message and the corresponding input message. The next stage of the method comprises training 602 a decoder, wherein the decoder comprises an AI/ML model, to generate the input message from the channel output symbols corresponding to the input message. The training determines a second set of parameters of the decoder. The second set of parameters is determined based on an objective function, which comprises the generated input message and the received channel output symbols corresponding to the input message as inputs. The objective function computes a measure of cross entropy between the generated input message and at least a part of the channel output symbols corresponding to the input message. With the decoder trained, the method then comprises the further steps of receiving 603 a further set of channel output symbols, and then using 604 the trained decoder to decode the further set of channel output symbols and generate an input message corresponding to the further set of channel output symbols. In embodiments, the second set of parameters is determined so as to minimize the objective function.

In an alternative embodiment, the training of the decoder uses labeled samples, with k^{th} labeled sample as (xᵢ,mᵢ)ₖ, where mᵢ∈ [symbol] ={1,2, . . . , M} represents an input message and Xᵢ∈ [symbol] is the corresponding encoded symbol at the input of the wireless channel, i.e. where xᵢ is the encoded symbol corresponding to message mᵢ obtained by an encoder.

Since the input to the decoder is channel output and the decoder has to infer the message contained in the channel output symbol yᵢ∈ [symbol] , when the available labeled data is (xᵢ,mᵢ)ₖ, it is necessary to generate yᵢ, i.e. the symbols at the channel output, for each xᵢ in the available labeled data. As yᵢ is the channel output symbol corresponding to channel input symbol xᵢ, yᵢ can be obtained from xᵢ by making xᵢ pass through a channel having required statistical distribution in a simulated environment. The method according to this embodiment thus requires the receipt of channel information and the application of the channel information to the samples xᵢ. This may be achieved by using one particular channel distribution Pⱼ(y|x) or a set of given set channel distributions (say, Pⱼ_{₁}(y|x), Pⱼ_{₂}(y|x), . . . Pⱼ_{ₙ}(y|x)),

Thus, by computing yᵢ for each xᵢ, another set of labeled data, denoted by {(yᵢ,mᵢ)ₖ}, is constructed. The decoder AI/ML model can now be trained using the labeled data {(yᵢ,mᵢ)ₖ}. For the decoder that is to be trained, this labeled data can be interpreted as follows: For the input yᵢ, mᵢ is the class label. The decoder is trained based on the set of labeled data samples, with the loss function given by cross entropy.

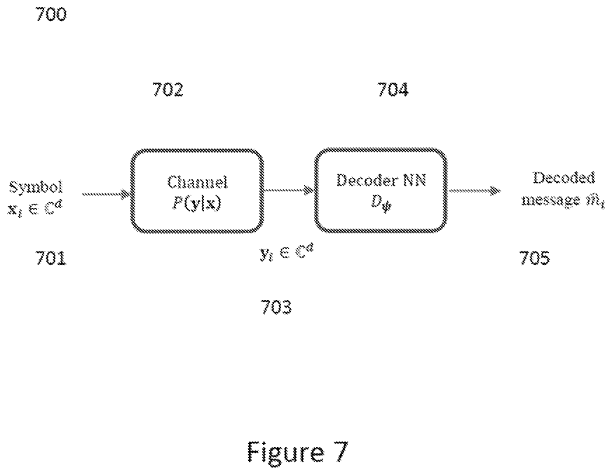

FIG. 7 is a diagram illustrating a system 700 for the interaction of the input xᵢ 701 of the channel 702, i.e. the symbols generated by the output yi 703 of the channel, the decoder 704 and the decoded message 705.

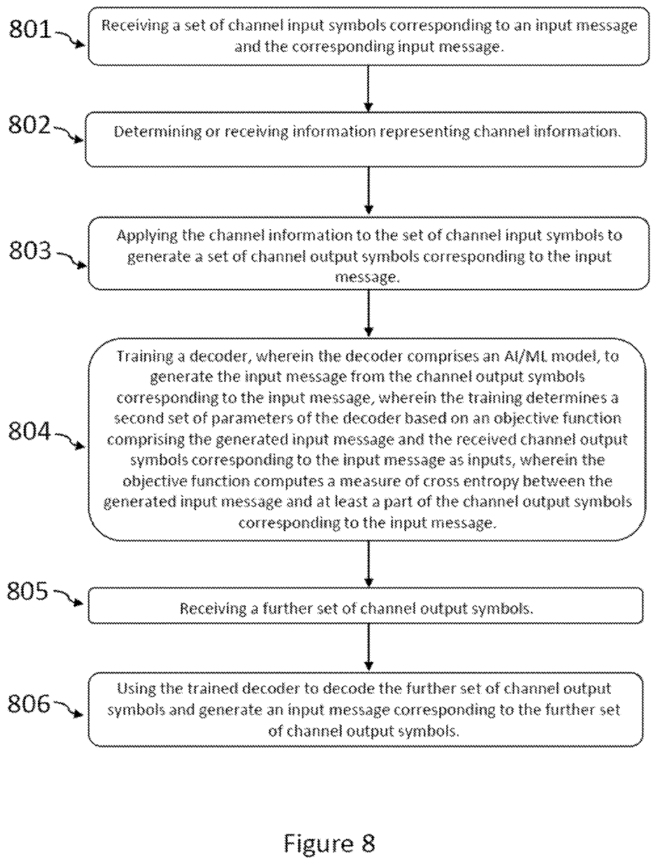

FIG. 8 is a flow chart illustrating a method of training a decoder according to an embodiment, wherein the labelled data comprises (xᵢ,mᵢ) data. As with the first embodiment, the method is implemented in at a second device of a radio communication network. The method comprises receiving 801 a set of channel input symbols corresponding to an input message and the corresponding input message. Since the labelled data comprises values which represent the input to the channel, the channel characteristics need to be known and need to be applied to the channel input symbols in order to generate a set of channel output symbols, which may then be used to train the decoder.

The method therefore further comprises receiving or generating 802 information representing channel information. The channel information is applied 803 to the set of channel input symbols to generate a set of channel output symbols corresponding to the input message.

The next stage of the method comprises training 804 a decoder, wherein the decoder comprises an AI/ML model for generating the input message from the channel output symbols corresponding to the input message. The training determines a second set of parameters of the decoder. The second set of parameters is determined based on an objective function, which comprises the generated input message and the received channel output symbols corresponding to the input message as inputs. The objective function computes a measure of cross entropy between the generated input message and at least a part of the channel output symbols corresponding to the input message. With the decoder trained, the method then comprises the further steps of receiving 805 a further set of channel output symbols, and then using 806 the trained decoder to decode the further set of channel output symbols and generate an input message corresponding to the further set of channel output symbols. In implementations the input message is determined based on one or more of a predefined value or a received indication. In embodiments, the second set of parameters is determined so as to minimize the objective function.

The proposed methods according to the above embodiments, in which separate training of the encoder and decoder is performed, enables the deployment of un-matched/un-paired encoders and decoders in a communication link. Any one of the methods for training an encoder according to the above embodiments may be used to train encoders, and any method for training a decoder according to the above embodiments may be used for devices in a network. The proposed methods make the encoder and the decoder independent, allowing the deployment encoder and decoder that are not-jointly trained.

In a set of n encoders E¹, . . . , Eⁿ, that are trained according to embodiments by, for example, different vendors, to communicate a set of M messages over a channel characterized by Pⱼ(y|x), each encoder has been trained to map M different information messages to complex symbols by maximizing the mutual information. This results in the outputs of each of the encoders having very similar statistical characteristics.

A decoder may be trained to work for the same channel characterized by Pⱼ(y|x), by a method according to an embodiment, using, for example, (xᵢ,mᵢ)ₖ as the labeled training data, where xᵢ is the encoded symbols produced by one of the encoders from the set of already trained encoders E¹, . . . , Eⁿ. For example, xᵢ may correspond to the encoded symbols produced by encoder Eⁿ. The decoder trained by using the encoded symbols from the encoder Eⁿ, would deliver reasonable performance even when used in conjunction with an encoder E^{j}, where j≠n. This is because the encoded symbols produced by all the encoders will have a similar statistical characteristic.

Thus, a decoder trained by using a particular encoder output can be expected to work well when used along with any of the trained encoders, as long as all the encoders and the decoders are trained using the above described methods.

Thus, if we train encoders and decoders training methods according to the proposed methods, the encoder and the decoder will no longer be strongly paired with each other and this enables the deployment of an arbitrary encoder at the transmitter and an arbitrary decoder at the receiver, provided all the encoders and all the decoders are trained for the same set of information messages [symbol] ={1, 2, . . . , M} and for the same channel Pⱼ(y|x).

The methods described above for the training of an encoder involve training using a particular channel distribution, Pⱼ(y|x), or a set of channel distributions, i.e. over samples that correspond to more than one channel distribution, say Pⱼ_{₁}(y|x), Pⱼ_{₂}(y|x), . . . Pⱼ_{ₙ}(y|x). However, the statistical characteristics of a wireless channel are time varying. These changes in channel characteristics mean that corresponding changes in the parameters of the encoder AI/ML model may be required, since it is possible that the channel distribution changes so that it is different from the distribution over which the encoder AI/ML model has been trained. In other words, P(y|x) changes, while P(x) remains unchanged, to Pₖ(y|x) where Pₖ(y|x) is different from the channel distributions over which the encoder AI/ML model has been trained.

When the difference between the channel distribution encountered by the encoder AI/ML model in the field is considerably different from the channel distribution(s) over which it has been trained, the mapping of messages mᵢ to symbols xᵢ by the trained encoder AI/ML model may not be maximize I (mᵢ;yᵢ). Such a situation requires the updating the encoder AI/ML model at an affordable cost. Updating may also be referred to as adapting or retraining. These terms can be used interchangeably.

In the existing methods, which are based on training the encoder AI/ML model with decoding error probability at the output of the decoder as the loss function, the decoder needs to feedback decoding error probabilities for retraining the encoder AI/ML model.

In the proposed method of training the encoder AI/ML model, it suffices to know the channel variations at the encoder AI/ML model for updating the encoder AI/ML model. Based on the channel knowledge at the encoder AI/ML model, the transmitting node can update the encoder AI/ML model according to the changed channel. A method of implementing the updating in response to a change in channel conditions according to embodiments will now be described.

For a message mᵢ, the encoder AI/ML model produces xᵢ based on the model parameters denoted by the vector ω. Based on the channel knowledge, the first device computes respective values of yᵢ corresponding to xᵢ and then computes the loss function by computing the mutual information between mᵢ and yᵢ. The encoder AI/ML model parameters, ω, are adjusted to reduce the loss function.

In Time Division Duplex (TDD) networks, obtaining the channel knowledge at the transmitter can be achieved in a very affordable manner by exploiting the channel reciprocity. Thus, in a TDD network, the above explained method of adapting the encoder AI/ML model can be employed without any cost of additional feedback overhead. This is in contrast to existing AI/ML based E2E communications methods, wherein, even if channel information is obtained at the transmitter through channel reciprocity or some other means, feedback from the receiver to the transmitter is required, since the loss function depends on the decoding error probability at the decoder output and minimizing the loss function requires knowledge of the decoding error probability at the transmitter during the updating of the encoder AI/ML model.

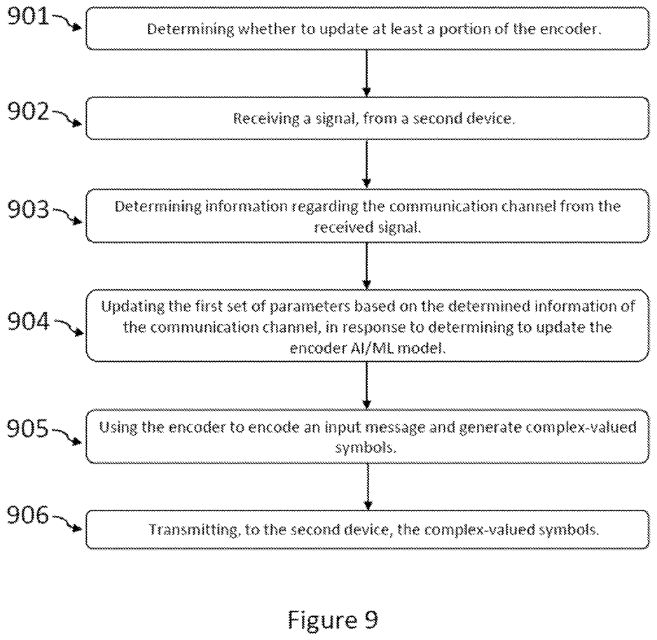

FIG. 9 is a flow chart illustrating a method of updating the encoder AI/ML model according to an embodiment. Firstly, a determination 901 is made as to whether to update at least a portion of the encoder. A signal is received 902 from a second device, and information regarding the communication channel from the received signal is determined 903. The first set of parameters, i.e. the parameters for the encoder AI/ML model is updated 904 based on the determined information of the communication channel, in response to a determination to update the encoder AI/ML model. Once the updating is completed, the encoder is used 905 to encode an input message and generate complex-valued symbols using the updated first parameters. The complex-valued symbols are then transmitted 906 to the second device.

In embodiments, the first set of parameters to be updated includes a structure of the encoder AI/ML model or weights of the encoder AI/ML model.

In embodiments, the determination as to whether to update the encoder AI/ML model is based on an indication from another device. In embodiments, the determination as to whether to update the encoder AI/ML model is based on changes in communication channel conditions.

In embodiments, determining whether to update the encoder AI/ML model is based on periodicity information indicating to the first device to update the AI/ML model at regular intervals of time.

For any given input message mᵢ, i=1, . . . , M, the encoder AI/ML model generates d≥1 complex-valued symbols, xᵢ∈ [symbol] . All the d symbols together convey the message mᵢ. The AI/ML model is trained during the training phase for either a particular channel distribution, i.e., one set of samples that correspond to a certain distribution of P(y|x), say Pⱼ(y|x), or over more than one type of channel distribution, i.e., over samples that correspond to more than one distribution of P(y|x), say Pⱼ_{₁}(y|x), Pⱼ_{₂}(y|x), . . . Pⱼ_{ₙ}(y|x).

For each message mᵢ, the encoder AI/ML model is trained to generate xᵢ SO that, when the decoder decodes the corresponding channel output yᵢ, the decoding error probability at the output of the decoder is minimized. However, if the channel distribution changes to new distribution Pₖ(y|x), which distorts/corrupts the input symbols more than the distribution, Pⱼ(y|x), over which the AI/ML model has been trained, the decoding error probability at the output of the decoder increases. The same applies if the AI/ML model has been trained over multiple distributions, and the new channel conditions distort the signal more than these distributions.

As the symbols xᵢ_{₁}, . . . , xᵢ_{_{d}} are generated by the encoder AI/ML model to represent the message mi, all the symbols collectively represent message mᵢ. However, when the channel conditions are poor, some of these symbols may get heavily corrupted making it difficult for the decoder to recover the underlying message mᵢ. In order to address this problem, a method of transforming the symbols such that each symbol in the transformed set of symbols contains information about each of the symbol generated by the encoder AI/ML model is provided.

According to an embodiment, such a transformation is achieved by multiplying the d-dimensional complex-valued vector xᵢ∈ [symbol] (which is, in other words, d complex-valued symbols) by a unitary matrix U∈ [symbol] to obtain a transformed set of symbols Sᵢ∈ [symbol] , where sᵢ=Uxᵢ. This procedure of pre-multiplying the symbols generated by the encoder AI/ML model before sending them over the wireless channel may be referred to as unitary transformation of the symbols or symbol vector, precoding or pre-processing of the symbols or the symbol vector. After the transformation, the pre-coded symbols s₁, . . . , S_{d} are sent over the channel over d channel uses.

Each transformed symbol sᵢ in the transformed vector sᵢ is a linear combination of xᵢ_{₁}, . . . , xᵢ_{_{d}}, the symbols generated by the encoder AI/ML model. Thus, each of the transformed symbols contains information about each of the symbols generated by the encoder AI/ML model. This enables the decoding of the original message even if a number of the symbols is significantly corrupted, since, if, even a few of the transformed symbols are received without significant corruption by the channel, then the decoder would be able to decode the message mᵢ from yᵢ, where yᵢ is the noisy and corrupted version of transformed symbol vector.

Since U is a unitary matrix having the property that UU*=U*U=I_{d×d}, where the superscript * denotes conjugate transpose and I_{d×d} is identity matrix of size d×d ∥sᵢ∥=∥xᵢ∥, which implies that there is no need to change the transmit power required to transmit sᵢ instead of transmitting xᵢ.

In an embodiment, the receiver node, i.e. the second device, is configured to continually observe the decoding error probability at the output of the decoder. Whenever the error probability increases above a threshold, the receiver signals the transmitter, i.e. the first device, to activate unitary transformation at the transmitter. The first device, accordingly, pre-multiplies the length-d complex-valued vector, consisting of the encoded symbols generated by the encoder AI/ML model, with a pre-decided unitary matrix and sends the resulting d complex-valued symbols over the channel.

The activation of the unitary transformation at the output of the encoder AI/ML model can also be implemented by monitoring the channel quality, either by the transmitter or the receiver, and triggering the transformation when the channel quality degrades below a threshold.

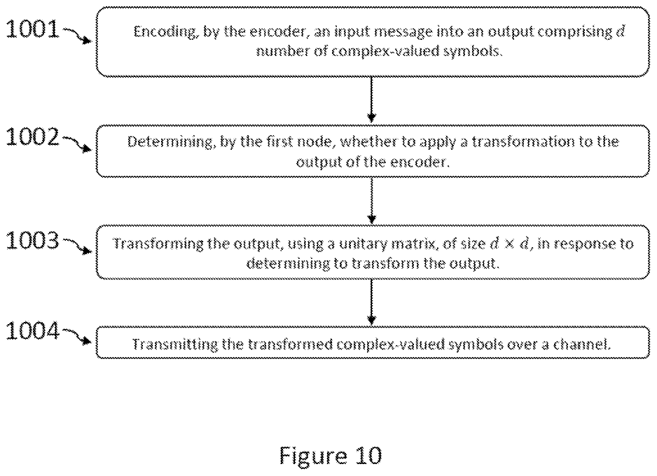

FIG. 10 is a flowchart illustrating a method of implementing a transformation according to an embodiment. An input message is encoded 1001 into an output comprising d number of complex-valued symbols. A determination 1002 is then made as to whether to transform the output. In response to determining to transform the output, the output is transformed 1003 using a unitary matrix, of size d×d. The transformed complex-valued symbols are then transmitted 1004 over a channel.

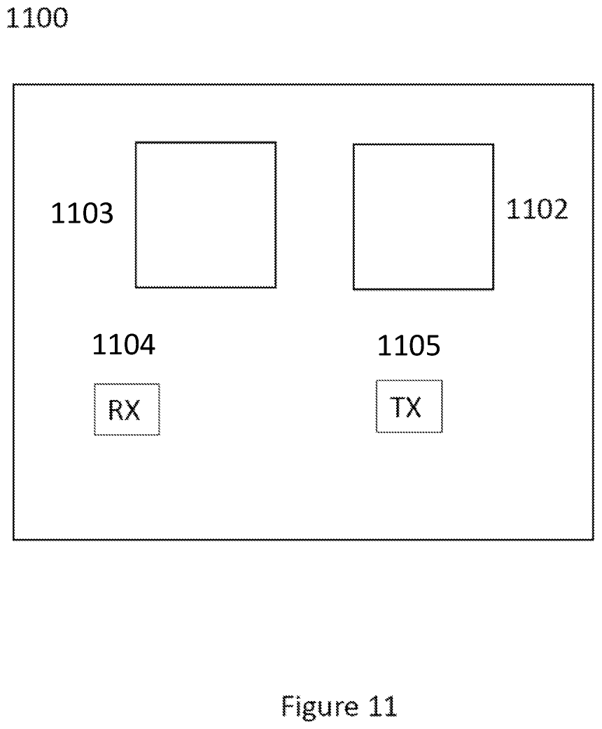

FIG. 11 is a diagram illustrating a device 1100 for implementing a method according to any of the previous embodiments. The device 1100 comprises a processor 1102, a memory 1103, a receiver 1104 and a transmitter 1105.

It will be appreciated by the person of skill in the art that various modifications may be made to the above described embodiments without departing from the scope of the claims.

What is claimed is:

1. An apparatus for wireless communication, comprising:
at least one memory; and
at least one processor coupled with the at least one memory and operable to cause the apparatus to:
train an encoder, wherein the encoder comprises at least a portion of an artificial intelligence/machine learning (AI/ML) model configured to generate a first number of complex-valued symbols from an input message, wherein to train the encoder is based at least in part on an objective function configured to receive input messages, respective complex-valued symbols, and a function representative of a wireless transmission link as inputs;
use the trained encoder to encode a further input message and generate further complex-valued symbols; and
transmit, to a second apparatus, the further complex-valued symbols.

2. The apparatus of claim 1, wherein to train the encoder is based at least in part on to maximize the objective function.

3. The apparatus of claim 1, wherein to train the encoder comprises to determine a set of parameters for using the AI/ML model, wherein the set of parameters specify the encoder AI/ML model and comprise a number of neural layers, a number of neurons in each layer, connections between neurons, weights of each neuron, values of hyper-parameters, and information of activation functions in the encoder AI/ML model.

4. The apparatus of claim 1, wherein the objective function is configured to compute a measure of mutual information between the input message and a function of communication channel information and the generated first number of complex-valued symbols.

5. The apparatus of claim 1, wherein the function representative of the wireless transmission link comprises communication channel information.

6. The apparatus of claim 5, wherein the function representative of the wireless transmission link further comprises hardware information for a first device and channel quality information at a second device.

7. The apparatus of claim 1, wherein a first device is configured to determine the function representative of the wireless transmission link based at least in part on an indication from one of: a second device or a third device, the third device being different from the second device.

8. The apparatus of claim 5, wherein the at least one processor is operable to cause the apparatus to receive at least one reference signal from a second device, and determine the channel information based on the received at least one reference signal.

9. An apparatus for wireless communication, comprising:
at least one memory; and
at least one processor coupled with the at least one memory and operable to cause the apparatus to:
receive a set of channel output symbols corresponding to an input message and a corresponding input message;
train a decoder, wherein the decoder comprises at least a portion of an artificial intelligence/machine learning (AI/ML) model configured to generate the input message from the channel output symbols corresponding to the input message, wherein to train the decoder comprises to determine a second set of parameters of the decoder based on an objective function taking the generated input message and the received channel output symbols corresponding to the input message as inputs, wherein the objective function is configured to compute a measure of cross entropy between the generated input message and at least a part of the channel output symbols corresponding to the input message;
receive a further set of channel output symbols; and
use the trained decoder to decode the further set of channel output symbols and generate an input message corresponding to the further set of channel output symbols.

10. The apparatus of claim 9, wherein to train the decoder comprises to determine a second set of parameters of the decoder to minimize the objective function.

11. The apparatus of claim 9, wherein a second device is configured to determine the input message based on one or more of a predefined value or an indication received from a first device or a third device, the third device being different from the first device.

12. The apparatus of claim 9, wherein the second set of parameters specify the decoder AI/ML model and comprise a number of neural layers, a number of neurons in each layer, connections between neurons, weights of each neuron, values of hyper-parameters, and information of activation functions in the decoder AI/ML model.

13. An apparatus for wireless communication, comprising:
at least one memory; and
at least one processor coupled with the at least one memory and operable to cause the apparatus to:
receive or generate a set of channel input symbols corresponding to an input message and a corresponding input message;
determine or receive channel information representing channel information;
apply the channel information to the set of channel input symbols to generate a set of channel output symbols corresponding to the input message;
train a decoder, wherein the decoder comprises at least a portion of an artificial intelligence/machine learning (AI/ML) model configured to generate the input message from the channel output symbols corresponding to the input message, wherein to train the decoder comprises to determine a second set of parameters of the decoder based on an objective function taking the generated input message and the received channel output symbols corresponding to the input message as inputs, wherein the objective function is configured to compute a measure of cross entropy between the generated input message and at least a part of the channel output symbols corresponding to the input message;
receive a further set of channel output symbols; and
use the trained decoder to decode the further set of channel output symbols and generate an input message corresponding to the further set of channel output symbols.

14. The apparatus of claim 13, wherein the to train the decoder comprises to determine a second set of parameters of the decoder to maximize the objective function.

15. The apparatus of claim 13, wherein a second device is configured to determine the input message based on one or more of a predefined value or an indication received from a first device or a third device, the third device being different from the first device.

16. The apparatus of claim 13, wherein the second set of parameters specify the decoder AI/ML model by indicating a number of neural layers, a number of neurons in each layer, one or more connections between neurons, a weight of each neuron, one or more values of hyper-parameters, and information of activation functions in the decoder AI/ML model.

17. An apparatus for wireless communication, comprising:
at least one memory; and
at least one processor coupled with the at least one memory and operable to cause the apparatus to:
determine whether to update at least a portion of an encoder;
receive a signal, from a second device, over a communication channel;
determine information regarding the communication channel from the received signal;
update a first set of parameters based on the determined information of the communication channel, in response to determining to update an encoder artificial intelligence/machine learning (AI/ML) model;
use the encoder to encode an input message and generate complex-valued symbols using the updated first parameters; and
transmit, to the second device, the complex-valued symbols.

18. The apparatus of claim 17, wherein the first set of parameters includes a structure of the encoder AI/ML model or weights of the encoder AI/ML model.

19. The apparatus of claim 17, wherein to determine whether to update the encoder AI/ML model is based on periodicity information indicating to the first device to transform output of the encoder at regular intervals of time.

20. The apparatus of claim 17, wherein to determine whether to update the encoder AI/ML model is based on an indication from another device.
